(19) United States
(12) Patent Application Publication
(10) Pub. No.: US 2014/0129742 A1
(43) Pub. Date: May 8, 2014

(54) NAK MODERATION IN USB2/USB1.1 BUSES

(71) Applicant: NVIDIA CORPORATION, Santa Clara, CA (US)

(72) Inventors: Chung-Hong Lai, Banciao (TW); Krishnaraj S. Rao, Bangalore (IN); Rahul Jain, Bangalore (IN)

(73) Assignee: NVIDIA CORPORATION, Santa Clara, CA (US)

(21) Appl. No.: 13/672,269

(22) Filed: Nov. 8, 2012

(51) Int. Cl. G06F 13/14

(52) U.S. Cl. 710/36

(57) ABSTRACT

A technique for controlling (e.g. (re)setting, adjusting, fixing, increasing, decreasing, determining, monitoring, calculating, measuring, storing) a holding time of a request from a controller of a host device to an endpoint of a peripheral device across a universal serial bus reduces power and memory loss and enhances overall system performance. The host device may include a programmable and/or hardwired controller for controlling the amount of time before the request from the host device is initially sent and/or resent to the endpoint of the peripheral device across the universal serial bus.

### BACKGROUND OF THE INVENTION

1. Field of the Invention

Embodiments of the invention generally relate to computer systems and, more specifically, to improving the efficiency of data transmission across a universal serial bus.

2. Description of the Related Art

A universal serial bus is an industry standard protocol for connection, communication, and power supply between a host device and a peripheral device connected thereto. In general, the host device sends a request to the peripheral device for sending data to the peripheral device and for retrieving data from the peripheral device. After such a request is sent, the peripheral device sends a response to the host device indicating that the peripheral device is ready to receive or send data or is not ready to receive or send data or that an error has occurred.

Universal serial bus specifications require that, when a request by the host device is responded to by a rejection (such as a NAK or NYTE token or packet, as known in the art) indicating that the peripheral device is busy and/or cannot receive the request at that particular time, the host device resend the request at a later time. This “later time” however is not specified or controlled. The specifications also require the host device to send all requests to bulk or control endpoints of the peripheral device in a uniform manner. Thus, if there are only one or a few bulk or control endpoints, the rotation between these endpoints is quick and the time between two requests targeting the same endpoint is short. Consequently, an endpoint may not be ready to receive or transmit data when a request to receive or transmit data is resent to that endpoint after a previous request was rejected by the endpoint.

There are many drawbacks of this unspecified/uncontrolled timing and limited endpoint process. One drawback occurs when requests are resent too frequently and the requests are repeatedly rejected by an endpoint. If the host device resends the request too early, then the request may be rejected one, two, or more times before being accepted, which wastes power and memory. Another drawback occurs when requests are resent too infrequently and the endpoint is waiting to receive the request. If the host device waits too long to resend the request, then although the request may be accepted when sent, the overall system momentarily sits idle and thus performance is slower.

Accordingly, what is needed in the art is a technique for improving the efficiency of data transmission across universal serial buses.

### SUMMARY OF THE INVENTION

Embodiments of the invention include a method for controlling communication across a universal serial bus between a host device having a controller and a peripheral device having an endpoint. The method comprises adjusting a holding time of the controller based on operational information, wherein the holding time comprises an amount of time the controller waits before sending a request to the endpoint of the peripheral device; sending the request to the endpoint; determining that the request was rejected; waiting for the holding time to expire before resending the request; and upon expiration of the holding time, resending the request from the controller to the endpoint.

Embodiments of the invention include a non-transitory computer readable storage medium comprising instructions for a system having a host device for coupling to a peripheral device, wherein the host device includes a controller for communicating with an endpoint of the peripheral device via a universal serial bus. The system, when executing the instructions, carries out the steps of adjusting a holding time of the controller based on operational information, wherein the holding time comprises an amount of time the controller waits before resending a request to the endpoint of the peripheral device; sending the request to the endpoint; determining that the request was rejected; waiting for the holding time to expire before resending the request; and upon expiration of the holding time, resending the request from the controller to the endpoint.

Embodiments of the invention include a system for controlling communication across a universal serial bus that comprises a host device having a controller that communicates with an endpoint of a peripheral device via the universal serial bus. The controller is configured to perform the steps of adjusting a holding time of the controller based on operational information, wherein the holding time comprises an amount of time the controller waits before sending a request to the endpoint of the peripheral device; sending the request to the endpoint; determining that the request was rejected; waiting for the holding time to expire before resending the request; and upon expiration of the holding time, resending the request from the controller to the endpoint.

Advantages of the embodiments of the invention include reducing power and memory loss caused by repeated request rejections, increasing bandwidth usage across universal serial buses, and enhancing overall system performance and speed.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the invention.

FIG. 2 is a block diagram of a host device in communication with a peripheral device via a universal serial bus, according to one embodiment of the invention.

FIG. 3 is a flow diagram of method steps for adjusting a holding time before resending a request from a controller of a host device to an endpoint of a peripheral device, according to one embodiment of the invention.

FIG. 4 is a flow diagram of method steps for adjusting a holding time before resending a request from a controller of a host device to an endpoint of a peripheral device, according to one embodiment of the invention.

FIG. 5 is a flow diagram of method steps for adjusting a holding time before resending a request from a controller of a host device to an endpoint of a peripheral device, according to one embodiment of the invention.

### DETAILED DESCRIPTION

In the following description, numerous specific details are set forth to provide a more thorough understanding of embodiments of the invention. However, it will be apparent to one of skill in the art that the embodiments of the invention may be practiced without one or more of these specific details.

### System Overview

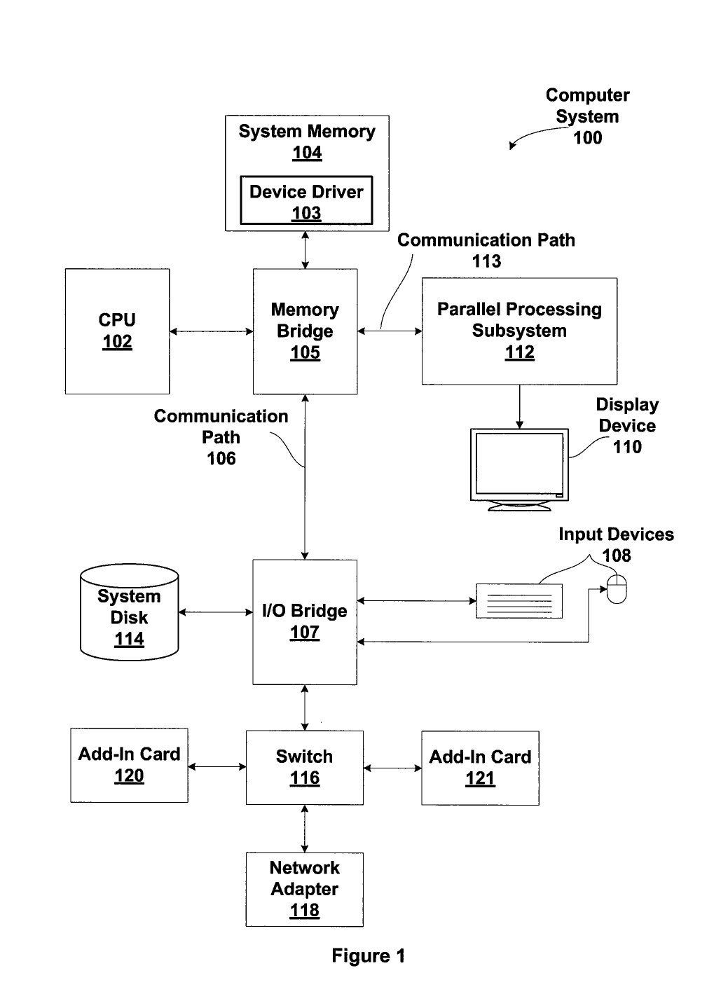

FIG. 1 is a block diagram illustrating a computer system 100 configured to implement one or more aspects of the invention. As show, computer system 100 includes, without limitation, a central processing unit (CPU) 102 and a system memory 104 that includes a device driver 103, all communicating via an interconnection path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via communication path 106 and memory bridge 105.

A parallel processing subsystem 112 is coupled to memory bridge 105 via a bus or second communication path 113 (e.g., a Peripheral Component Interconnect (PCI) Express, Accelerated Graphics Port, or HyperTransport link). In one embodiment, parallel processing subsystem 112 is a graphics subsystem that delivers pixels to a display device 110 that may be any conventional cathode ray tube, liquid crystal display, light-emitting diode display, or the like. A system disk 114 is also connected to I/O bridge 107 and may be configured to store content and applications and data for use by CPU 102 and parallel processing subsystem 112. System disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices.

A switch 116 provides connections between I/O bridge 107 and other components such as a network adapter 118 and various add-in cards 120 and 121. Other components (not explicitly shown), including universal serial bus (USB) or other port connections, compact disc (CD) drives, digital versatile disc (DVD) drives, film recording devices, and the like, may also be connected to I/O bridge 107. The various communication paths shown in FIG. 1, including the specifically named communication paths 106 and 113 may be implemented using any suitable protocols, such as PCI Express, AGP (Accelerated Graphics Port), HyperTransport, or any other bus or point-to-point communication protocol(s). Connections between different devices may also use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements in a single subsystem, such as joining the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip instead of existing as one or more discrete devices. Large embodiments may include two or more CPUs 102 and two or more parallel processing subsystems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

### NAK Moderation of Universal Serial Bus

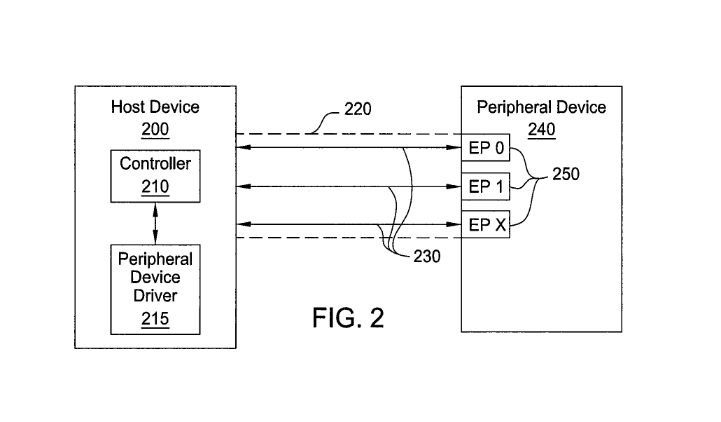

FIG. 2 is a block diagram of a host device 200 in communication with a peripheral device 240 via a universal serial bus 220, according to one embodiment of the invention. The host device 200 may include one or more components of the computer system 100 described above, such as a central processing unit, a system memory, a device driver, a parallel processing subsystem, etc. The host device 200 is illustrated in FIG. 2 as having an I/O controller 210 (such as a controller for I/O bridge 107) and a peripheral device driver 215 (such as device driver 103) for communicating with the peripheral device 240.

The peripheral device 240 may similarly include one or more components of the computer system 100 described above, such as a display device, input devices (e.g. keyboard, mouse, printer), etc. that communicate with the host device 200. The peripheral device 240 is illustrated in FIG. 2 as having endpoints 250 identified as EP0, EP1, EPX, although the device may include any number of endpoints as known in the art. The endpoints 250 may include any logic entity as known in the art on the peripheral device 240 for communicating with the controller 210. The controller 210 is operable to send and retrieve data (or packets of data) to and from the peripheral device 240 via the universal serial bus 220. In particular, data is communicated across the universal serial bus 220 to each endpoint 250 via one or more pipes 230, such as transmission lines and/or logic channels as known in the art. The pipes 230 may be configured as bidirectional or unidirectional data transfer channels.

The universal serial bus 220 may include any type of communications protocols known in the art for connecting, communicating, and/or supplying power between devices, including but not limited to low, full, and high speed bus protocols, USB 1.1, and/or USB 2.0 communication protocols. Data transfer types across the universal serial bus 220 may include control transfers for sending commands, isochronous transfers for sending data at a guaranteed data rate, interrupt transfers for guaranteed immediate responses, and bulk transfers for using all available bandwidth for large data transmissions. One or more endpoints 250 may be configured to only handle specific types of data transfers.

During a communication across the universal serial bus 220, data is transmitted between the host device 200 and the peripheral device 240. Initially, all data is sent from the host device 200 to the peripheral device 240. The data generally includes a request from the host device 200 to conduct an operation, such as to send and/or retrieve data. When a request is sent, the peripheral device 240 sends a response to the host device 200 indicating (1) that the peripheral device 240 successfully received the data (e.g. an acceptance or an ACK token or packet as known in the art), (2) that the data cannot be received or the device is busy and should be retried (e.g. a rejection or a NAK or NYET token or packet as known in the art), or (3) that the device has an error condition and corrective action may be necessary before completing the data transfer (e.g. an error or a STALL token or packet as known in the art).

If a rejection is received, the host device 200 must resend the request at a later time. System power, memory, and performance are wasted by having the host device 200 repeatedly resend the same request to an endpoint 250 when busy, or by having the system remain idle while waiting for the request to be re-sent when the endpoint 250 is not busy. Embodiments of the invention thus include systems and methods for controlling and optimizing data transmission timing (based on operational information) between the host device 200 and the peripheral device 240 across the universal serial bus 220 to maximize power consumption, memory usage, and system performance.

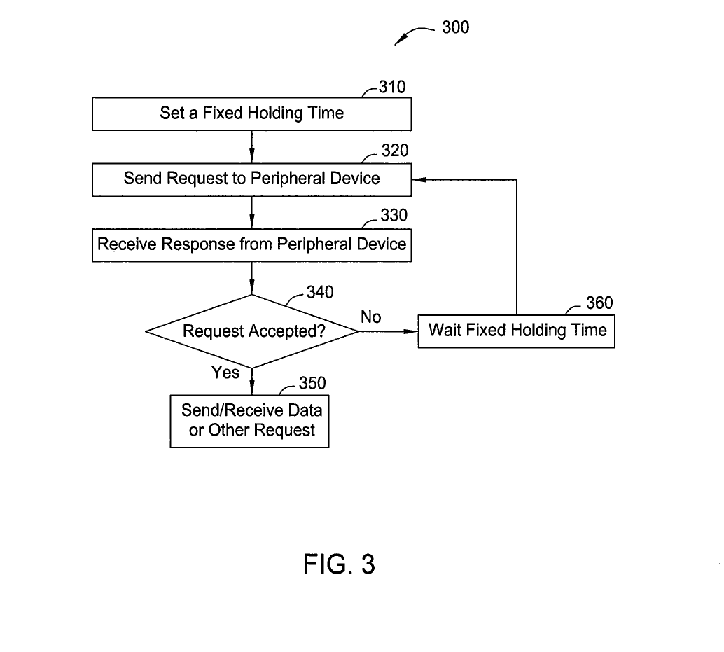

FIG. 3 illustrates a flow diagram of method steps for adjusting a holding time (based on operational information) before sending a request from a controller of a host device to an endpoint of a peripheral device, according to one embodiment of the invention. Although the method steps are described in conjunction with the systems of FIGS. 1 and 2, persons skilled in the art will understand that any system configured to implement the method steps, in any order, falls within the scope of the invention.

With respect to a method 300 shown in FIG. 3, the controller 210 may be operable to set a fixed amount of time or a “holding time” before initially sending a request and/or resending a previously rejected request to an endpoint 250 of the peripheral device 240. The fixed holding time may be a value that is programmable to the controller 210 and/or another component of the computer system 100. In one embodiment, the fixed holding time may be set to match the type or scheduling of interrupt and isochronous data transfers to the endpoints 250, i.e. initially sending and/or resending the request after requests for all interrupt and isochronous data transfers are sent to the requisite endpoints 250.

Referring now to FIG. 3, the method 300 includes an initial step 310 of setting a fixed holding time. In particular, the controller 210 may be programmed or hardwired to wait the fixed holding time before initially sending and/or resending a previously rejected request. At steps 320 and 330, the controller 210 sends an initial or previously rejected request to an endpoint 250 of the peripheral device 240, and then receives a response from the endpoint 250 of the peripheral device 240. The controller 210 determines if the response indicates that the request was accepted or not accepted at step 340. If the request was accepted, then the controller 210 may proceed to step 350 and send/receive data corresponding to the accepted request, if any.

Referring again to step 340, if the response indicates that the request was not accepted (e.g. rejected or that an error occurred), then the controller 210 may proceed to step 360 and wait the fixed holding time before resending the previously rejected request. Upon expiration of the fixed holding time, the controller 210 may repeat steps 320 and 330 by resending the request and receiving another response from the peripheral device 240 regarding the resent request. Steps 320, 330, 340, and 360 may be repeated any number of times until the request is accepted at step 340, and the corresponding data is communicated between the host device 200 and the peripheral device 240 at step 350.

The method 300 may be repeated any number of times for any number of requests sent by the controller 210 of the host device 200 to one or more endpoints 250 of the peripheral device 240. By waiting a fixed holding time before resending a previously rejected request, the controller 210 is operable reduce the risk of resending requests too frequently or too infrequently. The controller 210 may therefore reduce the risk of power and memory loss, and enhance system performance.

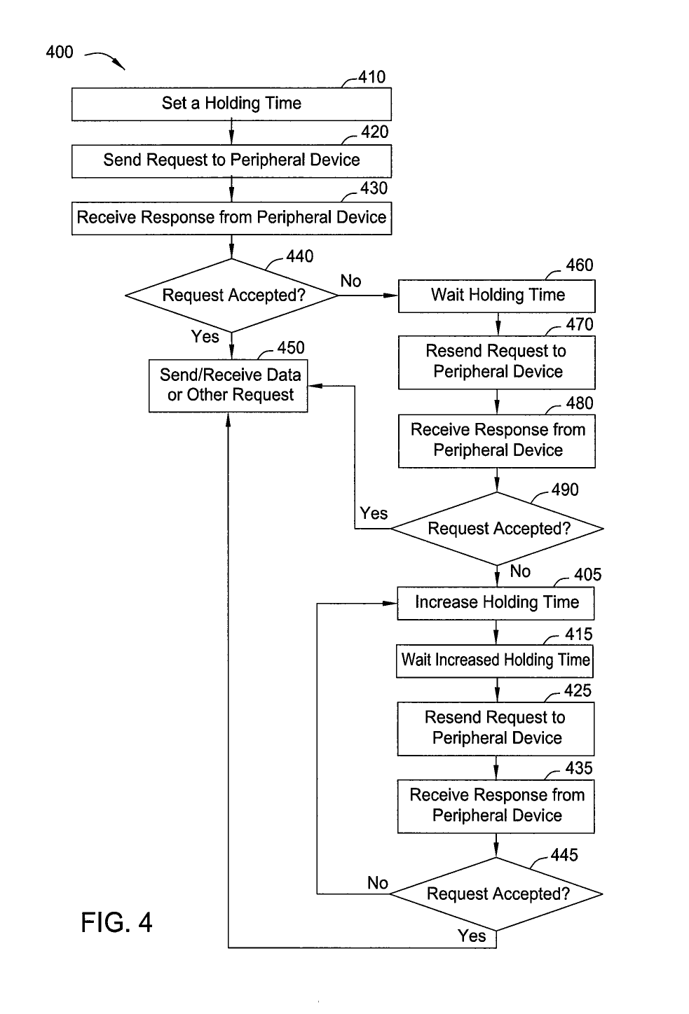

FIG. 4 illustrates a flow diagram of method steps for adjusting a holding time (based on operational information) before resending a request from a controller of a host device to an endpoint of a peripheral device, according to one embodiment of the invention. Although the method steps are described in conjunction with the systems of FIGS. 1 and 2, persons skilled in the art will understand that any system configured to implement the method steps, in any order, falls within the scope of the invention.

With respect to a method 400 shown in FIG. 4, the controller 210 may be operable to set, reset, and/or adjust a holding time before initially sending a request and/or resending a previously rejected request to an endpoint 250 of the peripheral device 240. When the endpoint 250 continuously rejects the request, the controller 210 may adjust, such as (exponentially) increase, the holding time before resending the request. For example, the holding time may be set to 5 microseconds for the first three rejections (such as NAK or NYTE tokens or packets as known in the art) received from the endpoint 250, and then set to 10 microseconds for the next three rejections, and finally set to 20 microseconds for any further rejections received until the request is accepted by the endpoint 250. The holding time may be reset to 5 microseconds and follow the previously described time adjustment pattern when the endpoint 250 receives and/or accepts the request. One or more holding times and/or time adjustment patterns may be values programmable to the controller 210 or hardwired in the host device 200.

Referring now to FIG. 4, the method 400 includes an initial step 410 of setting a holding time. In particular, the controller 210 may be programmed or hardwired to wait the holding time before initially sending and/or resending a previously rejected request. At steps 420 and 430, the controller 210 sends an initial or previously rejected request to the peripheral device 240, and then receives a response from the peripheral device 240. The controller 210 determines if the response indicates that the request was accepted or not accepted at step 440. If the request was accepted, then the controller 210 may proceed to step 450 and send/receive data corresponding to the accepted request, if any.

If, in step 440, the response indicates that the request was not accepted (e.g. rejected or that an error occurred), then the controller 210 may proceed to steps 460, 470, and 480, and wait until the expiration of the initial holding time before resending the previously rejected request and receiving another response from the peripheral device 240. Thereafter, the controller 210 may again determine if the response indicates that the request was accepted or not accepted at step 490. If the request was accepted, then the controller 210 may proceed to step 450 and send/receive data corresponding to the accepted request, if any, as previously described herein.

If, in step 490, the response indicates that the request was again not accepted (e.g. rejected or that an error occurred), then the controller 210 may proceed to step 405 and increase the holding time. After waiting until the expiration of the increased holding time, the controller 210 may proceed to resend the previously rejected request and receive another response from the peripheral device 240 as indicated at steps 415, 425, and 435, respectively. Thereafter, the controller 210 may again determine if the response indicates that the request was accepted or not accepted at step 445. If the request was accepted, then the controller 210 may proceed to step 450 and send/receive data corresponding to the accepted request, if any, as previously described herein.

If, in step 445, the response indicates that the request was again not accepted (e.g. rejected or that an error occurred), then the controller 210 may return to step 405 and increase the holding time again. In this fashion, the holding time may be continually increased by a preset or programmable value, and/or may be increased after a preset or programmable number of rejections of a request.

The method 400 may be repeated any number of times for any number of requests sent by the controller 210 of the host device 200 to one or more endpoints 250 of the peripheral device 240. By adjusting the holding time before resending a previously rejected request, the controller 210 is operable reduce the risk of resending requests too frequently or too infrequently. The controller 210 may therefore reduce the risk of power and memory loss, and enhance system performance.

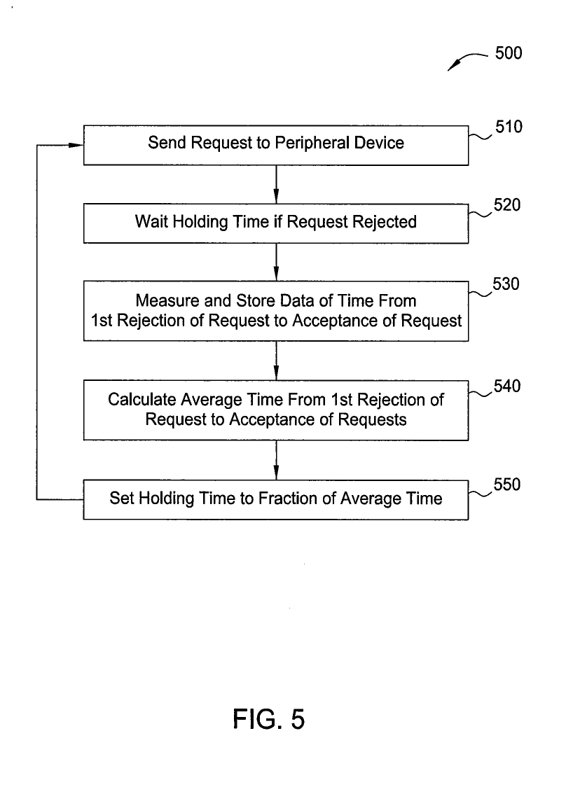

FIG. 5 illustrates a flow diagram of method steps for adjusting a holding time (based on operational information) before resending a request from a controller of a host device to an endpoint of a peripheral device, according to one embodiment of the invention. Although the method steps are described in conjunction with the systems of FIGS. 1 and 2, persons skilled in the art will understand that any system configured to implement the method steps, in any order, falls within the scope of the invention.

The controller 210 may be operable to set, reset, measure, store, calculate, and/or adjust holding times based on an endpoint's behavior. The controller 210 may measure and store data regarding the time between the first rejection of a request and the acceptance of the request by an endpoint 250. The time data measured and stored may be averaged by the controller 210 to calculate an average time that the endpoint 250 rejects requests. The holding time may then be set by the controller 210 to a fraction of the average time that the endpoint 250 rejects requests. The holding time may be continuously adjusted by the controller 210 as additional data is measured and stored, and the average time recalculated and updated.

Referring now to FIG. 5, the method 500 includes an initial step 510 of the controller 210 sending a request to an endpoint 250 of the peripheral device 240. The controller 210 may be programmed or hardwired to wait a holding time before initially sending and/or resending a previously rejected request at step 520. At step 530, the controller 210 measures and stores data that corresponds to the time from receiving a first rejection of a request to acceptance of that request. At step 540, the controller 210 calculates an average time from the first request rejection to request acceptance data. At step 550, the controller 210 resets the holding time to a preset or programmable fraction of the calculated average time. The controller 210 may then return and repeat step 510 of sending another request. The controller 210 may then wait until the expiration of the reset holding time at step 520. As the method 500 is repeated for multiple requests, the controller 210 continuously measures and stores data for calculating the average time, thereby improving the accuracy of the holding time to a fraction of the calculated average time.

The method 500 may be repeated any number of times for any number of requests sent by the controller 210 of the host device 200 to one or more endpoints 250 of the peripheral device 240. By continuously calculating an average time to acceptance and adjusting the holding time to a fraction of the average time before resending a previously rejected request, the controller 210 is operable reduce the risk of resending requests too frequently or too infrequently. The controller 210 may therefore reduce power and memory loss, and enhance system performance.

In one embodiment, the controller 210 may be operable to control a holding time based on information from the peripheral device 240, an endpoint 250 of the peripheral device 240, and/or the peripheral device driver 215. The controller 210 may obtain information directly from the peripheral device 240, the endpoint 250, and/or the device driver 215. The information may include the type of peripheral device or endpoint, endpoint descriptors, and/or holding times to be used for the peripheral device 240. In one embodiment, the information may be stored in a database on the device driver 215 and may be retrieved by/sent to the controller 210. In one embodiment, the information may be stored on the peripheral device 240 and may be retrieved by/sent to the controller 210 directly and/or through the device driver 215 via the universal serial bus 220.

Embodiments of the invention include one or more combinations (in whole or in part) of the embodiments described herein.

In sum, embodiments of the invention include a system and method for adjusting (e.g. (re)setting, controlling, fixing, increasing, decreasing, determining, monitoring, calculating, measuring, storing) a holding time of a request (based on operational information) from a controller of a host device to an endpoint of a peripheral device across a universal serial bus. During operation, the controller of the host device may send one or more requests to the endpoint of the peripheral device. The endpoint, however, may be busy and/or otherwise unable to accept and process the request at that time. The holding time may be adjusted based on operational information, including but not limited to, a fixed value, a type of request, a scheduling of a request, a number of request rejections, a fraction of a calculated average time to request acceptance, and information regarding the (type, descriptor, holding time) of the endpoint and/or the peripheral device. The controller is operable to wait the holding time before resending the request to the endpoint to minimize the possibility that the endpoint is still busy and/or otherwise unable to accept and process the request. System power and memory are wasted by having the controller repeatedly resend the same request to an endpoint when busy. Conversely, system performance is reduced by idle time waiting for the request to be re-sent when the endpoint is not busy. Embodiments of the invention thus include a system and method for adjusting the amount of time before a request from the controller is initially sent and/or resent to an endpoint of the peripheral device across a universal serial bus.

Advantages of the embodiments of the invention described herein include reducing power and memory loss caused by repeated request rejections, increasing bandwidth usage across universal serial buses, and enhancing overall system performance and speed.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the invention is set forth in the claims that follow.

1. A method for controlling communication across a universal serial bus between a host device having a controller and a peripheral device having an endpoint, comprising:
adjusting a holding time of the controller based on operational information, wherein the holding time comprises an amount of time the controller waits before sending a request to the endpoint of the peripheral device;
sending the request to the endpoint;
determining that the request was rejected;
waiting for the holding time to expire before resending the request; and
upon expiration of the holding time, resending the request from the controller to the endpoint.

2. The method of claim 1, wherein the operational information comprises at least one of a fixed value, a request type, a request schedule, a predetermined number of request rejections, a fraction of a calculated average time to request acceptance, and an endpoint or peripheral device type, descriptor, or holding time.

3. The method of claim 1, wherein adjusting the holding time comprises setting the holding time to a fixed value.

4. The method of claim 1, wherein adjusting the holding time comprises increasing the holding time.

5. The method of claim 4, further comprising increasing the holding time after receiving a predetermined number of rejections of the previously rejected request.

6. The method of claim 1, further comprising measuring and storing data regarding the time from receiving a first request rejection to receiving an acceptance of the rejected request.

7. The method of claim 6, further comprising calculating an average time based on the measured and stored data, and wherein adjusting the holding time comprises setting the holding time to a fraction of the calculated average time.

8. The method of claim 1, further comprising obtaining the operational information from the peripheral device or from a device driver of the peripheral device.

9. A non-transitory computer readable storage medium comprising instructions for a system having a host device for coupling to a peripheral device, wherein the host device includes a controller for communicating with an endpoint of the peripheral device via a universal serial bus, wherein the system executing the instructions carries out the steps of:
adjusting a holding time of the controller based on operational information, wherein the holding time comprises an amount of time the controller waits before resending a request to the endpoint of the peripheral device;
sending the request to the endpoint;
determining that the request was rejected;
waiting for the holding time to expire before resending the request; and
upon expiration of the holding time, resending the request from the controller to the endpoint.

10. The medium of claim 9, wherein the operational information comprises at least one of a fixed value, a request type, a request schedule, a predetermined number of request rejections, a fraction of a calculated average time to request acceptance, and an endpoint or peripheral device type, descriptor, or holding time.

11. The medium of claim 9, wherein adjusting the holding time comprises increasing the holding time.

12. The medium of claim 9, further comprising measuring and storing data regarding the time from receiving a first request rejection to receiving an acceptance of the rejected request, calculating an average time based on the measured and stored data, and adjusting the holding time to a fraction of the calculated average time.

13. A system for controlling communication across a universal serial bus, comprising:
a host device having a controller that communicates with an endpoint of a peripheral device via the universal serial bus, wherein the controller is configured to perform the steps of:
adjusting a holding time of the controller based on operational information, wherein the holding time comprises an amount of time the controller waits before sending a request to the endpoint of the peripheral device;
sending the request to the endpoint;
determining that the request was rejected;
waiting for the holding time to expire before resending the request; and
upon expiration of the holding time, resending the request from the controller to the endpoint.

14. The system of claim 13, wherein the operational information comprises at least one of a fixed value, a request type, a request schedule, a predetermined number of request rejections, a fraction of a calculated average time to request acceptance, and an endpoint or peripheral device type, descriptor, or holding time.

15. The system of claim 13, wherein adjusting the holding time comprises setting the holding time to a fixed value.

16. The system of claim 13, wherein adjusting the holding time comprises increasing the holding time.

17. The system of claim 16, further comprising increasing the holding time after receiving a predetermined number of rejections of the previously rejected request.

18. The system of claim 13, wherein the controller is configured to perform the steps of measuring and storing data regarding the time from receiving a first request rejection to receiving an acceptance of the rejected request.

19. The system of claim 18, wherein the controller is configured to perform the steps of calculating an average time based on the measured and stored data, and wherein adjusting the holding time comprises setting the holding time to a fraction of the calculated average time.

20. The system of claim 13, wherein the controller is configured to perform the steps of obtaining the operational information from the peripheral device or from a device driver of the peripheral device.
